(19) United States
(12) Patent Application Publication
(10) Pub. No.: US 2005/0066312 A1
(43) Pub. Date: Mar. 24, 2005

(54) Inter-job breakpoint apparatus and method

(75) Inventors: Eric Lawrence Barsness, Pine Island, MN (US); Gregory Christopher Place, Rochester, MN (US); John Matthew Santosuosso, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/666,032

(22) Filed: Sep. 18, 2003

(51) Int. Cl. G06F 9/44

(52) U.S. Cl. 717/129

(57) ABSTRACT

An apparatus and method provide inter-job breakpoints by defining a condition for a first job and an action for a second job. When the condition in the first job is satisfied, the action in the second job is performed. The condition in the first job can be the start of execution of a specified portion of code in the first job, the end of execution of a specified portion of code in the first job, or the satisfying of some other condition(s) in the first job. The action in the second job can be the halting of the second job or the enabling of a breakpoint in the second job. Inter-job breakpoints greatly enhance the utility of a debugger by performing an action in one job based on a detected condition in a different job.

### BACKGROUND OF THE INVENTION

1. Technical Field

This invention generally relates to computer systems, and more specifically relates to apparatus and methods for debugging computer programs.

2. Background Art

Since the dawn of the computer age, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated computer software has evolved to take advantage of the higher performance of the hardware, resulting in computer systems today that are much more powerful than just a few years ago.

As the sophistication and complexity of computer software increase, the more difficult the software is to debug. Debugging is the process of finding problems, or “bugs”, during the development of a computer program. Most modern programming environments include a debugger that provides tools for testing and debugging a computer program. Known debuggers allow the user to set one or more breakpoints in the computer program, which are points where the execution of the computer program is stopped so that the state of the program can be examined to verify that the program executed as designed.

One problem with known debuggers is they only operate on a single processing job at a time. However, in modern computer systems, there may be many jobs all running simultaneously that interact with each other and may thus affect each other's state and function. Known debuggers do not allow setting a breakpoint in one job that affects the operation of a different job. Without a mechanism and method for performing some action in a job when a condition in a different job is satisfied, the computer industry will continue to suffer from inefficient methods and tools for debugging interoperability issues between cooperating jobs.

### DISCLOSURE OF INVENTION

According to the preferred embodiments, an apparatus and method provide inter-job breakpoints by defining a condition for a first job and an action for a second job. When the condition in the first job is satisfied, the action in the second job is performed. The condition in the first job can be the start of execution of a specified portion of code in the first job, the end of execution of a specified portion of code in the first job, or the satisfying of some other condition(s) in the first job. The action in the second job can be the halting of the second job or the enabling of a breakpoint in the second job. Inter-job breakpoints greatly enhance the utility of a debugger by performing an action in one job based on a detected condition in a different job.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a block diagram showing two jobs;

FIG. 3 is a flow diagram in accordance with the preferred embodiments for performing an action in one job based on a detected condition in a different job;

FIG. 4 is a block diagram showing two jobs with a breakpoint condition for one job specified in the other job;

FIG. 5 is a block diagram of a first specific method within the scope of method 300 in FIG. 3 that breaks execution of Job B based on a detected condition in Job A;

FIG. 6 is a block diagram showing two jobs with a breakpoint enable in one job that, when satisfied, enables the breakpoint in the second job;

FIG. 7 is a block diagram of a second specific method within the scope of method 300 in FIG. 3 that enables the breakpoint specified in Job B based on a detected condition in Job A;

FIG. 8 is a block diagram showing the use of a monitor program to affect execution of one job based on a detected condition in a different job; and

FIG. 9 is a block diagram of a system that has multiple breakpoints defined in several different jobs.

### BEST MODE FOR CARRYING OUT THE INVENTION

The present invention is used in a programming environment for developing computer programs. For those who are not familiar with software development techniques, the brief overview below provides background information that will help the reader to understand the present invention.

### 1. Overview

Modern Programming Environments

Computer programs are constructed using one or more programming languages. Like words written in English, a programming language is used to write a series of statements that have particular meaning to the drafter (i.e., the programmer). The programmer first drafts a computer program in human readable form (called source code) prescribed by the programming language, resulting in a source code instruction stream. The programmer then uses mechanisms that change the human readable form of the computer program into a form that can be understood by a computer system (called machine readable form, or object code). These mechanisms are typically called compilers; however, it should be understood that the term “compiler” generically refers to any mechanism that transforms one representation of a computer program into another representation of that program.

This machine readable form is typically a stream of binary instructions (i.e., ones and zeros) that make up operational codes (known as op codes) that are meaningful to the computer. The compiler typically compiles each human readable statement into one or more machine readable instructions. Compilers generally translate each human readable statement in the source code instruction stream into one or more intermediate language instructions, which are then converted into corresponding machine-readable instructions. Once the machine-readable instructions have been generated, the computer program may be run on the computer system it was designed for.

Computer programs typically include one or more program variables that contain data of interest. These variables are typically represented by text labels in high-level and intermediate code computer programs. The concept of program variables is well known in the art.

Modern programming environments may provide many different combinations of features. For example, most programming environments include an editor or browser that displays source code to the programmer on a display device. A compiler is used, as explained above, to generate machine code from source code. A linker may also be included to allow sub-portions of the program to be separately compiled and linked together after compilation. Some programming environments include target hardware, which is the hardware on which the computer program is intended to run. Others may provide a simulator in software to “run” the code to simulate how the target hardware would respond to the computer program. Most modern programming environments also provide a debugger to help a programmer to locate problems in a computer program.

Debugging a Computer Program

For a computer program of any complexity, the program will likely not perform exactly as intended due to programmer errors, known as “bugs”, in the computer program. To help a programmer locate the bugs in his or her program, most modern programming environments provide a debugger that gives the programmer a variety of different tools for locating bugs. For example, a typical debugger includes a breakpoint capability that stops the execution of the program when a specified event in the computer program occurs. Once the program execution is stopped, the debugger typically allows the programmer to examine memory and status information to determine whether or not the program is in the proper state. A debugger may also allow a programmer to specify conditions and run a “program trace”, which writes to memory a list of all events of interest to the programmer without stopping the execution of the code.

One problem that exists with known debuggers is they do not have the ability to perform an action in one job based on some condition that is detected in a different job. Known debuggers are limited to debugging a single job, which makes the debugging of multiple jobs running simultaneously very difficult, especially when the multiple jobs are dependent on each other.

### 2.0 Detailed Description

The present invention makes debugging of multiple dependent jobs much easier by providing inter-job breakpoints, where a condition in a first job may trigger an action in a second job. The condition may include the start of execution of a specified portion of code in the first job, the end of execution of a specified portion of code in the first job, or the satisfying of some other condition(s) in the first job. The action may include halting the second job or enabling a breakpoint in the second job. Inter-job breakpoints allow debugging complex problems in multiple code portions that would otherwise be very difficult to debug.

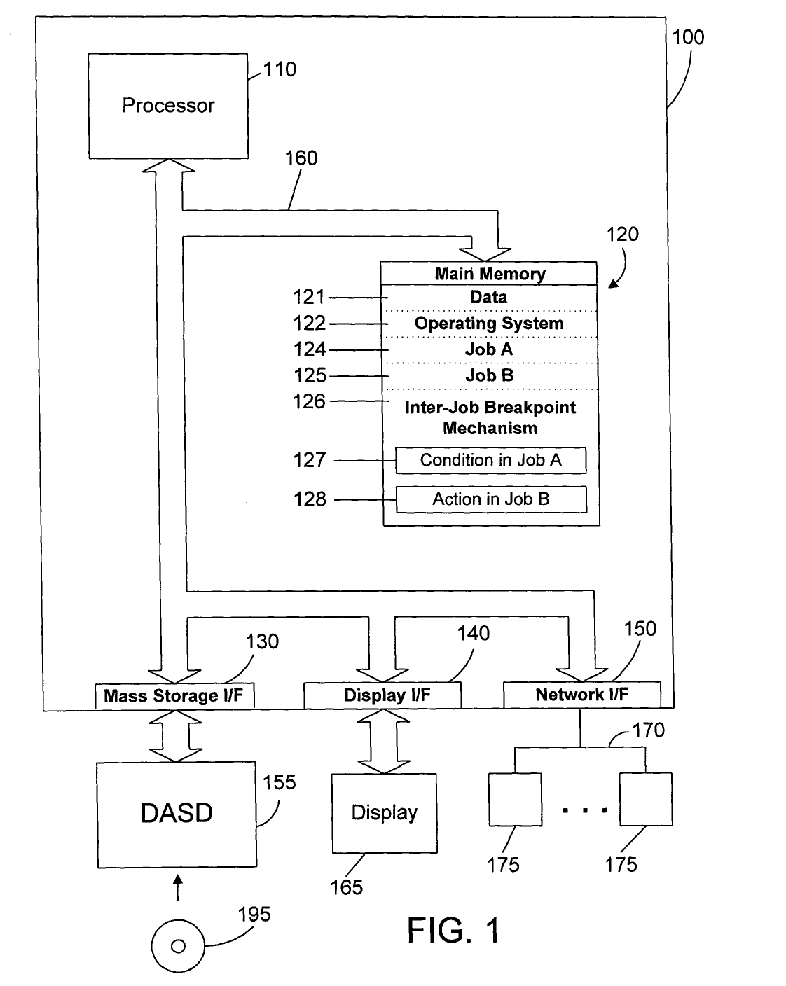

Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices (such as a direct access storage device 155) to computer system 100. One specific type of direct access storage device 155 is a readable and writable CD RW drive, which may store data to and read data from a CD RW 195.

Main memory 120 in accordance with the preferred embodiments contains data 121, an operating system 122, a first job 124, a second job 125, and an inter-job breakpoint mechanism 126. Data 121 represents any data that serves as input to or output from any program in computer system 100. Operating system 122 is a multitasking operating system known in the industry as OS/400; however, those skilled in the art will appreciate that the spirit and scope of the present invention is not limited to any one operating system. Jobs 124 and 125 are computer programs that run independently and asynchronously with respect to each other, but which have interaction with each other. Inter-job breakpoint mechanism 126 is preferably implemented within an integrated development environment, which is a computer program development environment that integrates together the creation and debugging of a computer program. An integrated development environment may include an editor, compiler, linker, and simulator.

The inter-job breakpoint mechanism 126 allows setting a breakpoint that specifies a condition 127 in a first job and a corresponding action 128 on a second job. When the condition 127 is satisfied, the corresponding action 128 is performed. Examples of conditions 127 within the scope of the preferred embodiments include the start of execution of a particular portion of code in the first job, the end of execution of a particular portion of code in the first job, or any other suitable condition or set of conditions. Examples of actions 128 within the scope of the preferred embodiments include the halting of the second job, the enabling of a breakpoint in the second job, the modifying of a variable or other property on the second job, and the outputting of a debug message to the second job's output.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, jobs 124 and 125, and inter-job breakpoint mechanism 126 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links.

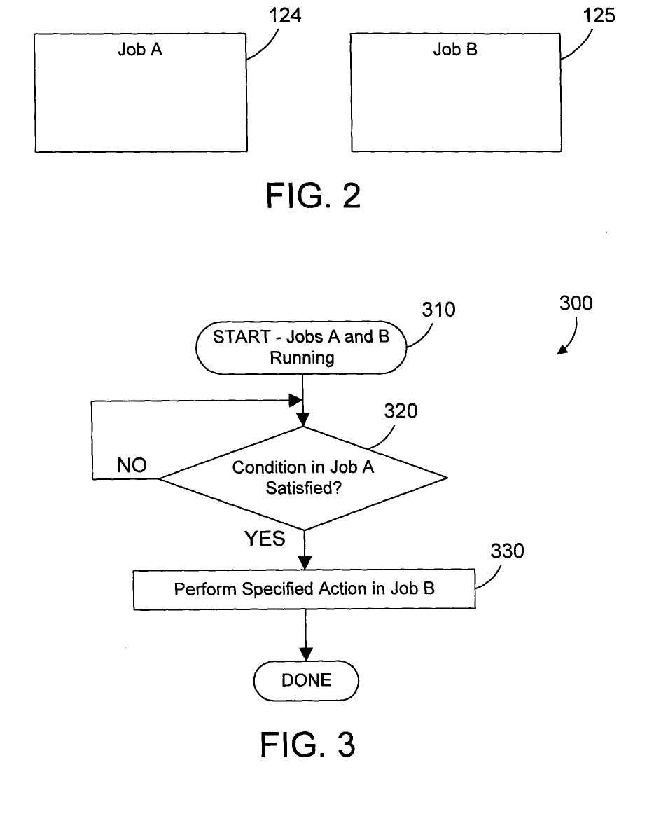

FIG. 2 represents the two jobs 124 and 125 shown in FIG. 1. In the preferred embodiments, these jobs are separately executing code portions that interact in some way. A method 300 in FIG. 3 represents steps performed by the inter-job breakpoint mechanism 126 of FIG. 1. Method 300 begins after jobs 124 and 125 are both running (step 310). We assume that a condition in job 124 is specified, and a corresponding action in job 125 is specified to define an inter-job breakpoint. Note that this breakpoint can be defined before the jobs start running or after the jobs start running. Method 300 monitors the execution of the jobs to see if the condition in job 124 is satisfied. If not (step 320=NO), method 300 loops back and waits until the condition in job 124 is satisfied (step 320=YES). Once the condition in job 124 is satisfied (step 320=YES), the specified action in job 125 is performed (step 330).

The concept of setting breakpoints across multiple jobs is powerful, because it allows debugging the interaction between different pieces of code. For example, the condition for the inter-job breakpoint could specify the beginning or end of execution of a portion of code in job 124, with the corresponding action being the halting of execution of job 125. One specific example where such an inter-job breakpoint would be useful is the debugging of a computer program that interacts with a database. Many database managers allow running a “trigger program” when data in a specified portion of the database is altered. Trigger programs are typically executed in separate jobs and could be executed any time a file is updated. An inter-job breakpoint mechanism of the present invention allows the condition to be set to the beginning of execution of the trigger program, and the action to be set to halting execution of a computer program executing in a different job. A different inter-job breakpoint could be defined that specifies a condition of the end of execution of the trigger program, with the action being the halting of execution of the computer program in the different job. These two inter-job breakpoints would allow a debugger to break a program when the trigger program is invoked, capture the environment, then upon return to the program capture the environment again when the trigger program completed. The inter-job breakpoints thus allow debugging the interoperability between two different pieces of code.

Examples of other suitable conditions that could be useful in debugging the interaction between multiple jobs is the execution of a program by a particular job, or the execution of a program at a specified time (or within a specified time frame). In addition, the condition could be the execution of a specified portion of code from a different computer program.

Another example that shows the utility and desirability of the inter-job breakpoints of the present invention is in debugging Java programs that use Java Database Connectivity (JDBC). When a Java program accesses a database via JDBC, two separate jobs are actually involved: 1) the job running the Java Virtual Machine (JVM), and 2) the job accessing the database. Using prior art debuggers, it is difficult to debug JDBC problems because there may be dozens or hundreds of database jobs running in support of a single JVM. Using an inter-job breakpoint of the present invention, we can debug complex problems. For example, threadsafety problems could be debugged by setting a condition in a database job and a specified action of halting the JVM. When the condition in the database job is satisfied, the JVM will be halted. Once halted, we can then determine which threads are accessing which database jobs and use this information to determine which two threads are trying to use the same database connection at the same time. Other applications where use of the inter-job breakpoint of the present invention would be useful include debugging Java Remote Method Invocation (RMI) problems and debugging interoperability problems between socket-connected applications.

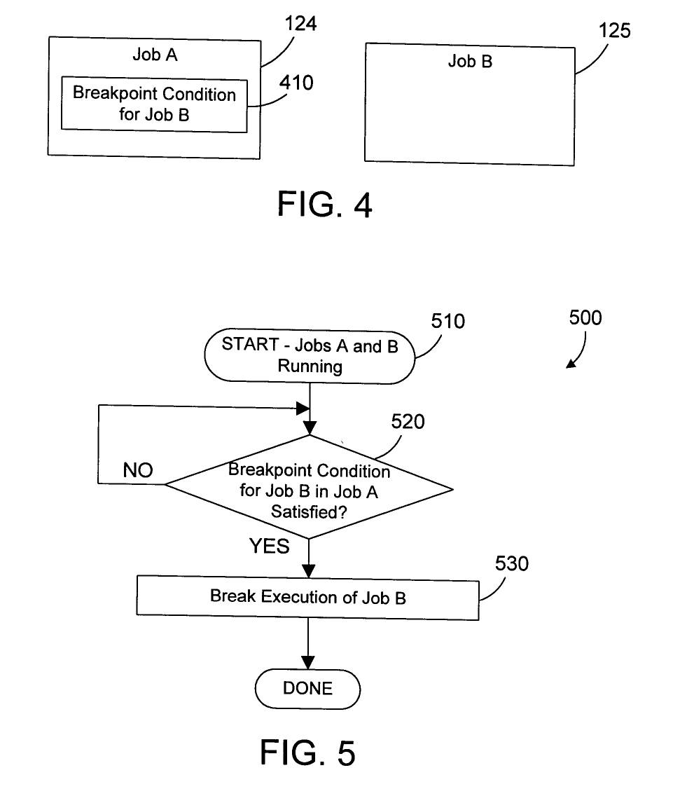

Specific implementations of FIGS. 2 and 3 are shown in FIGS. 4-8. In FIG. 4, a breakpoint condition 410 for job B is set in job A. Once the breakpoint condition 410 is satisfied, job B is halted. This is shown in method 500 in FIG. 5. Method 500 begins with jobs A and B both running (step 510). Method 500 waits (step 520=NO) until the breakpoint condition for job B in job A is satisfied (step 520=YES). At this point, method 500 breaks the execution of job B (step 530). FIGS. 4 and 5 thus show the specific example of an inter-job breakpoint that specifies a condition in job A, where the corresponding action is the breaking of job B in step 530.

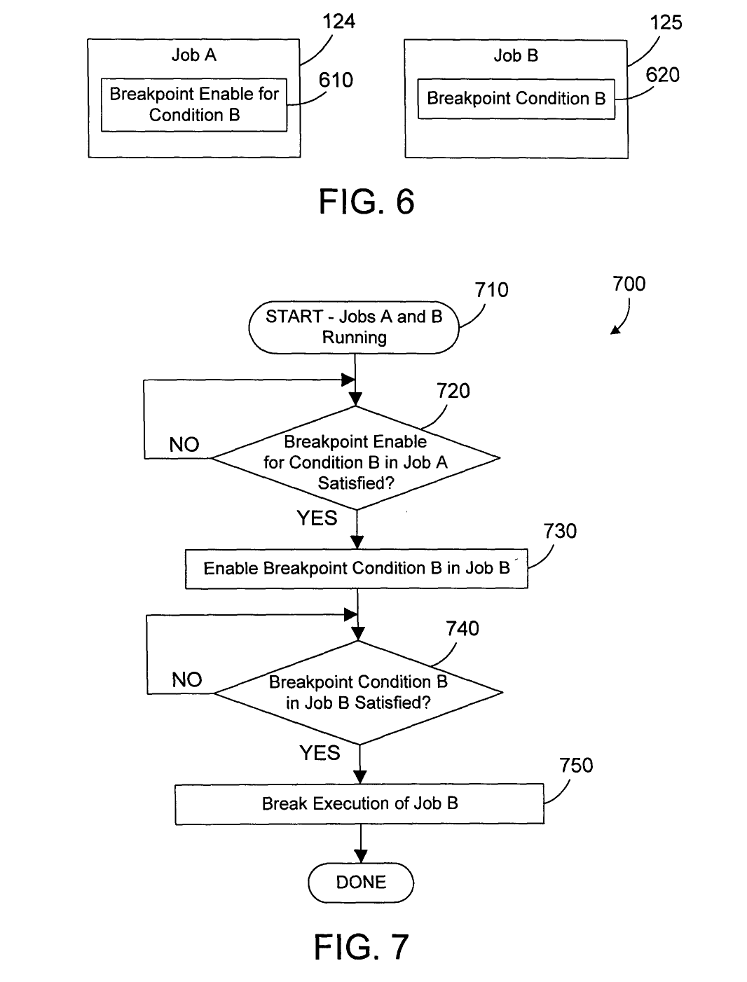

FIGS. 6 and 7 show another specific example of an inter-job breakpoint of the preferred embodiments. In FIG. 6, a first condition 610 is defined in job A, and a second condition 620 is specified in job B. When the first condition 610 in job A is satisfied, the breakpoint condition 620 in job B is enabled. Once the condition 620 is satisfied, the execution of job B is halted. This is shown in detail in FIG. 7. Method 700 begins with jobs A and B running (step 710). Method 700 waits (step 720=NO) until the breakpoint enable for condition B in job A is satisfied (step 720=YES). The breakpoint condition 620 in job B is then enabled (step 730). Method 700 then waits (step 740=NO) until the breakpoint condition B in job B is satisfied (step 740=YES). Once satisfied, method 700 breaks the execution of job B (step 750).

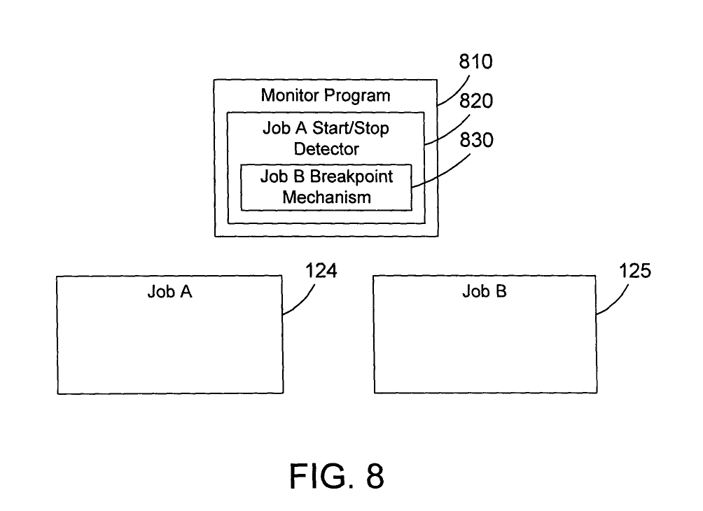

Note the implementation of method 700 in FIG. 7 could be performed via a monitor program 810 as shown in FIG. 8. Monitor program 810 includes a job A start/stop detector 820 and a job B breakpoint mechanism 830. Job A start/stop detector 820 detects when job A starts and stops. Job B breakpoint mechanism 830 monitors for breakpoint conditions in job B. The presence of both 820 and 830 in an external monitor program 810 allows inter-job breakpoints to be defined. For example, an inter-job breakpoint could be defined with a condition set to the starting of job A, with the action set to the enabling of a breakpoint in job B. Once this inter-job breakpoint is defined, the job A start/stop detector 820 will enable the job B breakpoint mechanism 830 when job A is started. Once enabled, the job B breakpoint mechanism 830 will break execution of job B when the conditions specified in the breakpoint for job B are satisfied.

The preferred embodiments shown in the figures and discussed above are very simple examples of inter-job breakpoints in accordance with the preferred embodiments. Note, however, that the simple concepts discussed herein provide a foundation for implementing various complex inter-job breakpoints within the scope of the preferred embodiments. For example, multiple stages may be defined for an inter-job breakpoint, where each condition, when satisfied, enables the next condition. In this manner, an interoperability issue between six cooperating jobs could be debugged by specifying a series of breakpoint conditions that are enabled one at a time by the preceding condition being satisfied.

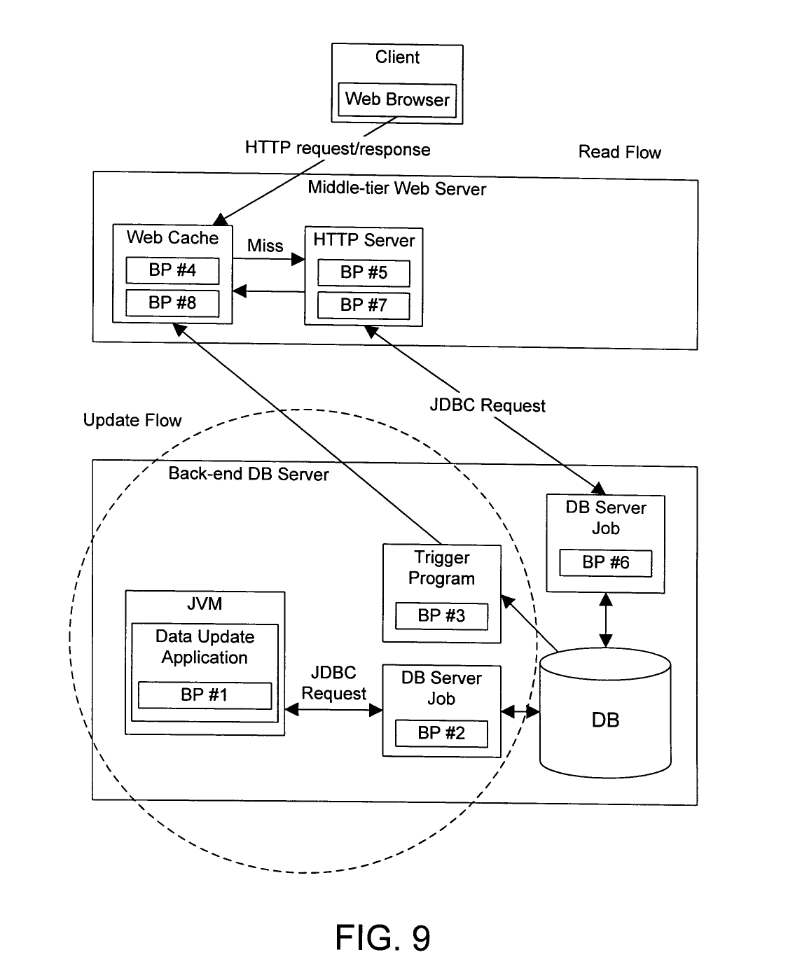

An example is now presented to illustrate the power of having a breakpoint in one job enable a breakpoint in another job to result in a series of breakpoints in different jobs that are enabled in cascaded fashion, one after the other. FIG. 9 shows a sample system. We assume that a bug has been discovered that a web page is dynamically generated with incorrect data. The question is, where is the bug? On the “update side” of the application flow, it could be bad input coming from a thread inside the JVM sending bad data to the database. It could be the database job that JDBC uses to access the database somehow messing up the data provided to it from the JVM. It could be that the trigger program that runs after the database has been updated is invalidating the wrong web page in the web cache. On the “read side” of the flow, it could be the Java code executing in the JVM of the HTTP server to generate the web page (either before or after accessing the database), or again it could be in the database jobs used by JDBC that read the data out of the database. It could also be the web cache doing something wrong.

A series of “cascading” breakpoints in accordance with the preferred embodiments could be set to track the flow that could be causing the problem. Known debuggers do not allow setting breakpoints in multiple jobs. Even if a known debugger were capable of setting breakpoints in multiple jobs, this is still not a desirable solution because each breakpoint could be hit a relatively large number of times. With the inter-job breakpoint of the preferred embodiments, the number of false hits may be reduced to avoid the impact of halting the application for unwanted breakpoints and wasting the time of the person debugging the code. In this case we could set a breakpoint in each job at key points, but make each one conditional on a previous breakpoint in another job. The first breakpoint (BP #1) would be set to go off when we think the update application starts going down the path that causes the problem. Hitting the first breakpoint enables the second breakpoint (BP #2) in a different job. Hitting the second breakpoint then enables the third breakpoint (BP #3) and so on, thus providing a cascading effect and avoiding the stopping of other jobs unnecessarily.

The preferred embodiments greatly enhances the debug capability known in the art by adding the capability of defining breakpoints across different jobs. Interoperability issues between different pieces of code can now be debugged because conditions in one job may cause actions, including the enabling of a breakpoint, to be performed in a different job.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

1. An apparatus comprising:
at least one processor;
a memory coupled to the at least one processor;
a first job residing in the memory and executed by the at least one processor;
a second job residing in the memory and executed by the at least one processor;
an inter-job breakpoint mechanism that detects at least one condition in the first job and, in response thereto, performs at least one action on the second job.

2. The apparatus of claim 1 wherein the at least one condition comprises the start of execution of a specified portion of code in the first job.

3. The apparatus of claim 1 wherein the at least one condition comprises the end of execution of a specified portion of code in the first job.

4. The apparatus of claim 1 wherein the at least one action comprises halting execution of the second job.

5. The apparatus of claim 1 wherein the at least one action comprises enabling a breakpoint in the second job.

6. The apparatus of claim 5 wherein the at least one action further comprises halting execution of the second job when at least one condition specified in the breakpoint in the second job is satisfied.

7. The apparatus of claim 1 wherein the at least one action comprises modifying a property on the second job.

8. The apparatus of claim 7 wherein the property comprises a program variable.

9. The apparatus of claim 1 wherein the at least one action comprises outputting of a debug message to the second job's output.

10. A method for debugging comprising the steps of:
defining at least one condition in a first job;
defining at least one action to take on a second job;
monitoring execution of the first job;
monitoring execution of the second job; and
when the at least one condition in the first job is satisfied, performing the at least one action on the second job.

11. The method of claim 10 wherein the at least one condition comprises the start of execution of a specified portion of code in the first job.

12. The method of claim 10 wherein the at least one condition comprises the end of execution of a specified portion of code in the first job.

13. The method of claim 10 wherein the at least one action comprises halting execution of the second job.

14. The method of claim 10 wherein the at least one action comprises enabling a breakpoint in the second job.

15. The method of claim 14 wherein the at least one action further comprises halting execution of the second job when at least one condition specified in the breakpoint in the second job is satisfied.

16. The method of claim 10 wherein the at least one action comprises modifying a property on the second job.

17. The method of claim 16 wherein the property comprises a program variable.

18. The method of claim 10 wherein the at least one action comprises outputting of a debug message to the second job's output.

19. A program product comprising:
(A) an inter-job breakpoint mechanism that monitors execution of first and second jobs, and when at least one condition in the first job is satisfied, performs at least one action on the second job; and
(B) computer-readable signal bearing media bearing the inter-job breakpoint mechanism.

20. The program product of claim 19 wherein the computer-readable signal bearing media comprises recordable media.

21. The program product of claim 19 wherein the computer-readable signal bearing media comprises transmission media.

22. The program product of claim 19 wherein the at least one condition comprises the start of execution of a specified portion of code in the first job.

23. The program product of claim 19 wherein the at least one condition comprises the end of execution of a specified portion of code in the first job.

24. The program product of claim 19 wherein the at least one action comprises halting execution of the second job.

25. The program product of claim 19 wherein the at least one action comprises enabling a breakpoint in the second job.

26. The program product of claim 25 wherein the at least one action further comprises halting execution of the second job when at least one condition specified in the breakpoint in the second job is satisfied.

27. The program product of claim 19 wherein the at least one action comprises modifying a property on the second job.

28. The program product of claim 27 wherein the property comprises a program variable.

29. The program product of claim 19 wherein the at least one action comprises outputting of a debug message to the second job's output.
